(19) United States
(12) Patent Application Publication
(10) Pub. No.: US 2026/0073016 A1
(43) Pub. Date: Mar. 12, 2026

(54) MECHANISM FOR PREVENTING ABNORMAL USER ACTIVITIES ASSOCIATED WITH PLATFORM INTERACTIONS

(71) Applicant: Play Games24x7 Private Limited, Mumbai (IN)

(72) Inventors: Rukma Ameet TALWADKER, Bengaluru (IN); Hussain JAGIRDAR, Bengaluru (IN); Tridib MUKHERJEE, Bengaluru (IN); Arnov KUMAR, Bangalore (IN)

(73) Assignee: Play Games24x7 Private Limited, Mumbai (IN)

(21) Appl. No.: 18/986,013

(22) Filed: Dec. 18, 2024

(30) Foreign Application Priority Data
Sep. 12, 2024 (IN) 202421069126

(51) Int. Cl. G06F 18/213; G06F 3/01; G06F 18/241

(52) U.S. Cl. CPC G06F 18/213; G06F 3/011; G06F 18/241

(57) ABSTRACT

A system (100) to prevent abnormal user activities associated with interactive platforms. The system (100) includes an abnormality analyzer engine (106) to receive data related to abnormal activities associated with the platform interactions of pre-identified abnormal users and to estimate parameters indicative of extent of abnormality associated with each of the pre-identified users based on the received data. The system also includes a user classification module (108) to classify the pre-identified abnormal users into sustained abnormal users instantaneous abnormal users based on the estimated parameters. The system also includes an abnormality predictor (110) to predict trajectory of abnormality of each of the sustained abnormal users based on the received data of the classified sustained abnormal users and to identify extremely abnormal users based on the predicted trajectories for taking actions to prevent abnormal user activities of the identified extremely abnormal users.

### FIELD OF THE INVENTION

The present invention relates to platform interactions. In particular, the present invention relates to a mechanism for preventing abnormal user activities associated with platform interactions.

### BACKGROUND OF THE INVENTION

Interactive platforms which provide engaging and immersive experiences are a rising phenomenon across the modern-day world and because of their very nature, regulation and careful monitoring of the related user activities is crucial. Compulsive behaviors like problem gaming and internet addiction are a cause of concern for regulators, policy makers, operators and consumers in view of consumer protection as they can lead to financial problems, mental health concerns and even issues in personal life of the users. This necessitates mechanisms to ensure platform interactions are engaged in a safe and a responsible manner and in a way that minimizes harm and promotes balanced activities associated with the interactions.

Further, the most common platform interactions involve exchange of value in terms of financial assets in return for the engaging experiences. During such interactions responsible activity must be ensured where users engage only within their resourceful means, which is paramount for the wellness of the users and also for their sustained engagement and retention with the platform. Users seldom self-identify their activity as abnormal and thus further necessitates mechanisms for automatic analysis and identification of abnormal user activities.

Conventional mechanisms provide for identification of users with abnormal activities during their interaction on the platforms and enable taking intervention measures for such users. However, certain users although indicate abnormal activities during specific instances, may moderate their activities from time to time and the conventional systems often identify abnormal activities related to sudden interactions which result in extreme outcomes in the immediate moment including the self-moderated users. These existing systems enable locating abnormal user activity using multiple parallel modes such as 1. a rule-based model which looks at various features of the interactions, 2. Intelligent models that capture normal user activities as reference to identify abnormal activities, and 3. a model based on users' interaction data to capture their psychological desperation. However, these solutions do not fully address the abnormal user activities and current mechanisms need to be improved.

As abovementioned, many users with abnormal activity have self-moderating tendencies wherein they self-control themselves following an instance of abnormal activity by either refraining from interacting for some time or controlling their time and assets following an abnormal activity of overspending of resources. Hence, even though abnormal activity identification systems may identify many users with abnormal activity in a single instances, they may oftentimes result in false identification of the users. Additionally, analysis of platform activities often indicate a low percent of users exhibiting abnormal activities. Further, many genuinely abnormal users, even when flagged by the systems and being put through intervention measures, remain unaffected due to non-cooperation to the intervention measures. A more effective approach is required for such users. Furthermore, the conventional mechanisms do not provide any interpretability and explainability as to when and why the activities of these users need to be intervened with for preventing further occurrences of abnormal activities.

Thus, there is a need for a mechanism for preventing abnormal user activities associated with platform interactions to overcome the abovementioned drawbacks.

### SUMMARY OF THE PRESENT INVENTION

In an embodiment of the present invention, a system to prevent abnormal user activities associated with interactive platforms is disclosed. The system includes an abnormality analyzer engine to receive data related to abnormal activities associated with the platform interactions of one or more pre-identified abnormal users and to estimate one or more parameters indicative of extent of abnormality associated with each of the one or more pre-identified users based on the received data. The system also includes a user classification module to classify the pre-identified abnormal users into sustained abnormal users and instantaneous abnormal users based on the estimated one or more parameters indicative of the extent of abnormality of the pre-identified users. The system further includes an abnormality predictor to predict trajectory of abnormality of each of the sustained abnormal users based on the received data of the classified one or more sustained abnormal users and to identify extremely abnormal users based on the predicted trajectories of the sustained abnormal users for taking actions to prevent abnormal user activities of the identified extremely abnormal users.

In an embodiment of the present invention, the data related to abnormal activities of a pre-identified user includes platform interaction data and abnormality scores of the user over a pre-defined duration.

In an embodiment of the present invention, the abnormality scores of the user are generated and the one or more users are pre-identified as abnormal based on the platform interaction data by employing a deep-learning model.

In an embodiment of the present invention, the one or more parameters indicative of the extent of abnormality of a user include average abnormality score acceleration, area under the curve of abnormality scores, angular displacements of consequent abnormality scores and cumulative loss of assets associated with the users over a pre-defined period.

In an embodiment of the present invention, the user classification module is to further estimate a net abnormality score of the each user based on the one or more parameters indicative of the extent of abnormality of the user for classifying the one or more pre-identified abnormal users into the sustained abnormal users and the instantaneous abnormal users.

In an embodiment of the present invention, the one or more sustained abnormal users and the one or more instantaneous abnormal users are classified by employing elbow point identification.

In an embodiment of the present invention, the abnormality predictor is to further determine one or more conditions associated with psychological states of the sustained abnormal users for predicting the trajectories by employing a Deep Markov Model and a Conditional Network.

In an embodiment of the present invention, the abnormality predictor is to further generate latent encodings for the received platform interaction data of the sustained abnormal users for mapping to latent space associated with the determined one or more conditions by employing a Conditional Variational Auto-Encoder with Latent Self-Organizing Map.

In an embodiment of the present invention, the Self-Organizing Map based topology is learnt over the entire conditional latent space, the Conditional Variational Auto-Encoder encodes platform interaction data to latent encodings, which are allocated to cluster-centroid embeddings of the conditional latent space such that, SOM like neighborhood properties are enforced on the latent space of the encoder which ensures to retain topological neighborhood properties between data points in the adjacent time periods enabling interpretability of the predictions.

In an embodiment of the present invention, predicting trajectory of the each user includes generating predictions for subsequent time steps within the mapped latent space by employing a Long short-term memory network with an Attention Layer.

In an embodiment of the present invention, the users with a high number of time steps indicative of increasing abnormality within the mapped latent space are identified as extremely abnormal users.

In an embodiment of the present invention, the Attention Layer is to identify one or more dominant time-steps in the predicted trajectory that lead to the predicted time-steps.

In an embodiment of the present invention, the abnormality predictor is to further identify platform activity features which have temporal relationship in explaining the predicted trajectory by employing a SHAP (SHapley Additive explanations) based model on the identified one or more dominant time-steps.

In an embodiment of the present invention, the system further includes an intervention module to communicate information related to abnormality assessment with the identified extremely abnormal users based on the predicted trajectories and to estimate a level of intervention required based on the information communicated with the extremely abnormal users for determining the actions to be taken for preventing abnormal activities of the identified extremely abnormal users.

In an embodiment of the present invention, a method for preventing abnormal user activities associated with interactive platforms is disclosed. The method includes receiving data related to abnormal activities associated with the platform interactions of one or more pre-identified abnormal users and estimating one or more parameters indicative of extent of abnormality associated with each of the one or more pre-identified users based on the received data. The method also includes classifying the pre-identified abnormal users into sustained abnormal users and instantaneous abnormal users based on the estimated one or more parameters indicative of the extent of abnormality of the pre-identified users. The method further includes predicting trajectory of abnormality of each of the sustained abnormal users based on the received data of the classified one or more sustained abnormal users and identifying extremely abnormal users based on the predicted trajectories of the sustained abnormal users for taking actions to prevent abnormal user activities of the identified extremely abnormal users.

In an embodiment of the present invention, the data related to abnormal activities of a pre-identified user includes platform interaction data and abnormality scores of the user over a pre-defined duration.

In an embodiment of the present invention, the abnormality scores of the user are generated and the one or more users are pre-identified as abnormal based on the platform interaction data by employing a deep-learning model.

In an embodiment of the present invention, the one or more parameters indicative of the extent of abnormality of a user include average abnormality score acceleration, area under the curve of abnormality scores, angular displacements of consequent abnormality scores and cumulative loss of assets associated with the users over a pre-defined period.

In an embodiment of the present invention, the method further includes estimating a net abnormality score of the each user based on the one or more parameters indicative of the extent of abnormality of the user for classifying the one or more pre-identified abnormal users into the sustained abnormal users and the instantaneous abnormal users.

In an embodiment of the present invention, the one or more sustained abnormal users and the one or more instantaneous abnormal users are classified by employing elbow point identification.

In an embodiment of the present invention, the method further includes determining one or more conditions associated with psychological states of the sustained abnormal users for predicting the trajectories by employing a Deep Markov Model and a Conditional Network.

In an embodiment of the present invention, the method further includes generating latent encodings for the received platform interaction data of the sustained abnormal users for mapping to latent space associated with the determined one or more conditions by employing a Conditional Variational Auto-Encoder with Latent Self-Organizing Map.

In an embodiment of the present invention, the Self-Organizing Map based topology is learnt over the entire conditional latent space, the Conditional Variational Auto-Encoder encodes platform interaction data to latent encodings, which are allocated to cluster-centroid embeddings of the conditional latent space such that, SOM like neighborhood properties are enforced on the latent space of the encoder which ensures to retain topological neighborhood properties between data points in the adjacent time periods enabling interpretability of the predictions.

In an embodiment of the present invention, predicting trajectory of the each user includes generating predictions for subsequent time steps within the mapped latent space by employing a Long short-term memory network with an Attention Layer.

In an embodiment of the present invention, the users with a high number of time steps indicative of increasing abnormality within the mapped latent space are identified as extremely abnormal users.

In an embodiment of the present invention, the Attention Layer identifies one or more dominant time-steps in the predicted trajectory that lead to the predicted time-steps.

In an embodiment of the present invention, the method further includes identifying platform activity features which have temporal relationship in explaining the predicted trajectory by employing a SHAP (SHapley Additive explanations) based model on the identified one or more dominant time-steps.

In an embodiment of the present invention, the method further includes communicating information related to abnormality assessment with the identified extremely abnormal users based on the predicted trajectories and to estimate a level of intervention required based on the information communicated with the extremely abnormal users for determining the actions to be taken for preventing abnormal activities of the identified extremely abnormal users.

### BRIEF DESCRIPTION OF DRAWINGS

The following drawings are illustrative of preferred embodiments for enabling the present invention and are not intended to limit the scope of the invention. The drawings are not to scale (unless so stated) and are intended for use in conjunction with the explanations in the following detailed description.

FIG. 1 is a block diagram illustrating a system to prevent abnormal user activities associated with interactive platforms in accordance with an embodiment of the present invention;

FIG. 2 illustrates an example graph illustrating abnormality score trajectory of a user in accordance with the present invention;

FIG. 3 is an example graph illustrating classification of abnormal users in accordance with the present invention;

FIG. 4 illustrates the deep learning neural network for predicting trajectory of abnormal activities in accordance with an embodiment of the present invention;

FIGS. 5(a) and 5(b) illustrate trajectories of abnormality of different users in accordance with an exemplary embodiment of the present invention; and

FIG. 6 is a flowchart illustrating a method for preventing abnormal user activities associated with interactive platforms in accordance with an embodiment of the present invention.

### DETAILED DESCRIPTION OF DRAWINGS

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used are for the purpose of describing exemplary embodiments and should not be considered limiting. Thus, the present invention is to be accorded the widest scope encompassing numerous alternatives, modifications, and equivalents consistent with the principles and features disclosed. For the purpose of clarity, details relating to technical material that is known in the technical fields related to the invention have not been described in detail so as not to unnecessarily obscure the present invention.

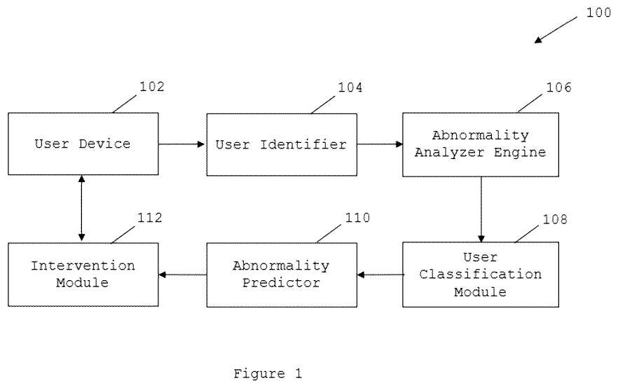

FIG. 1 is a block diagram illustrating a system 100 to prevent abnormal user activities associated with interactive platforms in accordance with an embodiment of the present invention. An interactive platform may include an environment that provides for engaging user experiences by way of interaction between the user and a device through digital content. An abnormal user activity may be understood as extreme platform engagement behavior associated with the user which may be risky or harmful to the user.

In an embodiment of the present invention, the system 100 may be implemented on a digital device, which may be communicatively coupled to one or more user devices associated with one or more users, such that platform interaction data of the one or more users may be obtained from the one or more user devices 102 to process the obtained data for determining the abnormal user activities. In another embodiment of the present invention, the system 100 may be implemented on a server such as a cloud based server, such that the one or more user devices may connect with the server via a wireless communication network like Internet.

The digital device may be any electronic or electrical device with a display screen, a controller and a network connectivity to connect with the one or more user devices 102 via a communication network. The user devices 102 may include for example a laptop, a desktop, a tablet, a gaming console, a television and a mobile phone.

In an embodiment of the present invention, the system 100 may include a user identifier 104, an abnormality analyzer engine 106, a user classification module 108, an abnormality predictor 110 and an intervention module 112. In an embodiment of the present invention, the user identifier 104, the abnormality analyzer engine 106, the user classification module 108, the abnormality predictor 110 and the intervention module 112 may be communicatively coupled to a memory and a processor of the system 100. Further, the processor may be configured to automatically control the operations of the user identifier 104, the abnormality analyzer engine 106, the user classification module 108, the abnormality predictor 110 and the intervention module 112.

In an embodiment of the present invention, the processor and the memory may form a part of a chipset installed in the system 100. In another embodiment of the present invention, the memory may be implemented as a static memory or a dynamic memory. In an example, the memory may be internal to the system 100. In another example, the memory may be implemented as an external memory for the system 100. The memory may be a cloud-based storage or onsite-based storage. Further, the processor may implemented be as one or more microprocessors, microcomputers, microcontrollers, digital signal processors, central processing units, state machines, logic circuitries, or any devices that manipulate signals, based on operational instructions.

In an embodiment of the present invention, the user identifier 104 may be configured to identify one or more abnormal users based on platform interaction data by employing a deep-learning model. The platform interaction data may be obtained from the one or more user devices 102. For identification of the one or more abnormal users, initially, various features of user activities associated with the interaction on the platform may be identified from the platform interaction data. For example, for a user activity of gaming on an online gaming platform, based on the gaming interaction data of the user, various features of the user's gameplay may be determined. In this example, the various features may include, without any limitation, count of add cash, count of late night games, games lost to total games ratio, count of limit change and total loss incurred in a certain period.

Further, time series of each of the features may be obtained for a pre-defined duration, by employing a time series forecasting technique. For example, Prophet time-series model may be employed. The deep learning model may further predict the abnormality scores of the user based on hyper parameters of the time-series model employed, which may include, without any limitation, base rate, change rate, periodogram and periodicity. For example, in the above mentioned scenario, time-series model of five features of gameplay may be obtained which may further generate 10 new hyper-parameters to be input to the deep-learning model for determining the abnormality scores.

In an embodiment of the present invention, the abnormality analyzer engine 106 may be configured to receive data related to abnormal activities associated with the platform interactions of the one or more pre-identified abnormal users. The data related to abnormal activities of a pre-identified user may include platform interaction data and abnormality scores of the user over a pre-defined duration. As aforementioned, the abnormality scores of the user may be generated and the one or more users may be pre-identified as abnormal based on the platform interaction data, by employing a deep-learning model.

In an embodiment of the present invention, the abnormality analyzer engine 106 may be further configured to estimate one or more parameters indicative of extent of abnormality associated with each of the one or more pre-identified users based on the received data related to abnormal activities of the pre-identified users. The one or more parameters indicative of the extent of abnormality of a user may include average abnormality score acceleration, area under the curve of abnormality scores, angular displacements of consequent abnormality scores and cumulative loss of assets associated with the users over the pre-defined period.

The average abnormality score acceleration maybe indicated by ‘A’ and may be estimated by the following: A=(^{L-1}ₗ₌₁Instance_A₁)/L−1;
wherein, Instance_A₁=NetChange₁/AverageChange₁

$${NetChange}_{1} = {AbnProb}_{1} - {AbnProb}_{1 + 1}$$

$${AverageChange}_{1} = ( {AbnProb}_{1} + {AbnProb}_{1 + 1} ) / 2$$

AbnProb₁ may be indicative of abnormality probability prediction for the user by the deep-learning model. Both NetChange₁ and AverageChange₁ may be estimated for L−1 consecutive time periods. L may be for example 12, when 12 weeks of data of the user may be received.

Another parameter, area under the curve of abnormality scores may indicate magnitude and the scale of abnormality via the abnormality scores of the each user. Area may be further scaled as different users may have varying observational data which comprises the platform interaction data. In the abovementioned example, L may be less than 12. Scaled Area may be indicated by B, which may be estimated as follows:

$$B = ( {}_{l = 1}^{L - 1} {Area}_{1} ) / ( L - 1 ) ;$$

wherein, Area₁=((AbnProb₁+AbnProbₗ₊₁)/2)*1
   Here, the area calculation may be based on the sum of the area of rectangles. The height of the rectangle is approximated to the average of lengths of the two sides and the width is always unity as two time-steps are just one step apart. The overall area is scaled to make this parameter comparable across various users with different time-steps of predictions available based on their activity length on the platform.

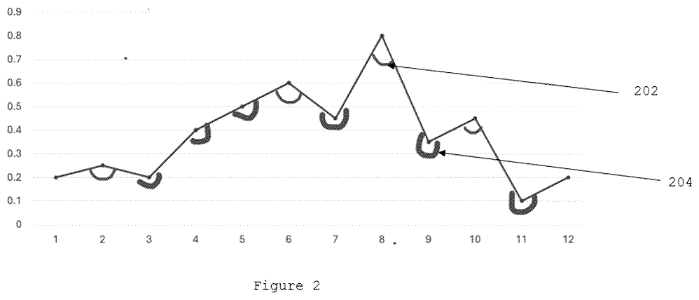

The third parameter of angular displacements of consequent abnormality scores may indicate a user's self-moderation of the platform activities. The angular displacements may be one of: convex and concave in shape. FIG. 2 illustrates an example graph illustrating abnormality score trajectory of a user in accordance with the present invention. In the FIG. 2, abnormality scores of the user (on y-axis) for 12 weeks duration (x-axis) and associated angular displacements with respect to every subsequent score is indicated. As shown in the FIG. 2, an interior angle/convex angle 202 which may be less than 180 degrees may be indicative of decreasing abnormal activity due to the user's self-moderation. Alternatively, a concave angle/exterior angle 204 that may be greater than or equal to 180 degrees may be indicative of continued or increased abnormal activity of the user. Average angular displacement indicated by ‘C’ may be estimated as follows:

$$C = ( Concave\_angular \_displacement - convex\_angular \_displacement ) * B$$

Where both Concave_angular_displacement and Convex_angular_displacement may indicate sum of total respective angular displacements. For example, in the FIG. 2 all the red, thickly marked angles may be summed to derive Concave_angular_displacement for the user and the green, thinly marked angles may be summed to derive the Convex angular displacement. To distinguish between two players with similar angle displacements but at a different magnitude of abnormality, the third parameter may be further scaled by the area under the curve (B).

The fourth parameter may be the cumulative loss of assets associated with the users over a pre-defined period. Assets may be understood an item of value associated with the user which may be utilized by the user as a resource for continued platform activity. The cumulative losses of a user over the pre-defined period may be obtained from the platform interaction data and may be further scaled or normalized with respect to the losses incurred by one or more other users. The cumulative loss may be indicated by ‘D’.

In an embodiment of the present invention, the user classification module 108 may be configured to estimate a net abnormality score of the each user based on the one or more parameters indicative of the extent of abnormality of the user for classifying the one or more pre-identified abnormal users based on the estimated net scores. The net abnormality score of a user may be calculated as a weighted sum of the one or more parameters, which may be expressed as for example: net_abn_score=0.1*A+0.3*B+0.2*C+0.4*D. The weights for each parameter may vary according to the specific platform for which the system 100 may be implemented.

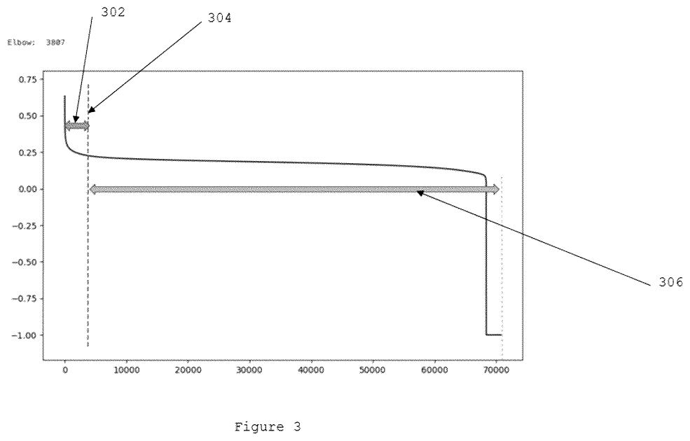

In an embodiment of the present invention, the user classification module 108 may be configured to classify the abnormal pre-identified users into sustained abnormal users and instantaneous abnormal users based on the net abnormality score of the each user which may be estimated as aforementioned, i.e., based on the estimated one or more parameters indicative of the extent of abnormality of the pre-identified users. The one or more sustained abnormal users and the one or more instantaneous abnormal users may be classified by employing elbow point identification technique. Elbow is the point where the rate of variance decreases sharply and levels off, indicating a cut-off. FIG. 3 is an example graph illustrating classification of abnormal users in accordance with the present invention. As shown in the FIG. 3, the users to the left 302 of the cutoff 304 may be those with high variance and may be classified as sustained abnormal users and the remaining users 306, to the right of the cutoff 304 with much flatter or decreasing variance may be classified as instantaneous abnormal users.

In an embodiment of the present invention, the abnormality predictor 110 may be configured to predict trajectory of abnormality of each of the sustained abnormal users based on the received data of the classified one or more sustained abnormal users by employing a deep learning neural network. In an embodiment of the present invention, the abnormality predictor 110 may be further configured to determine one or more conditions associated with psychological states of the sustained abnormal users for predicting the trajectories by employing a Deep Markov Model (DMM) and a Conditional Network.

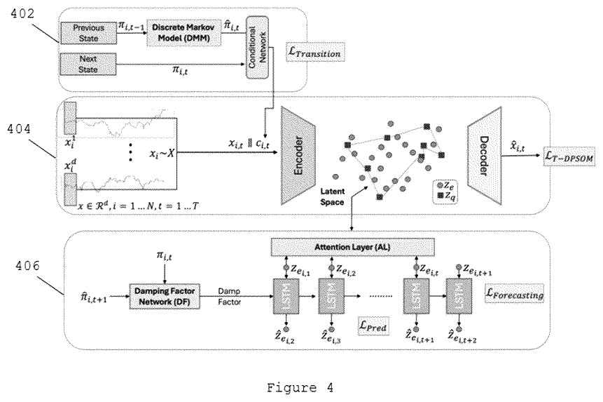

FIG. 4 illustrates the deep learning neural network for predicting trajectory of abnormal activities in accordance with an embodiment of the present invention. As shown in the FIG. 4, the deep learning neural network includes a Transition Module 402 which comprises the DMM and the Conditional Network, a Conditional Variational Auto-Encoder (Con-VAE) 404 and an Intelligent Forecasting Module 406 comprising a Damping Factor Network and a Long short-term memory (LSTM) network with an Attention Layer. The platform interaction data may be indicated as xᵢ={x_{i,1}, x_{i,2}, . . . , x_{i,T}}. A latent state maybe associated with each observation x_{i,t}, that may be indicative of a user's psychological state. As shown in the FIG. 4, the DMM may predict a subsequent latent state based on the previous state and the Conditional Network, based on the predicted next state and the actual next state, may generate the one or more conditions. The damping factor network may be configured to learn a damping factor between a latent state and the next latent state predicted by the DMM in order to dampen effects caused due to a sudden data pattern shift.

In an embodiment of the present invention, the abnormality predictor 110 may be further configured to generate latent encodings for f the received platform interaction data of the sustained abnormal users for mapping to latent space associated with the determined one or more conditions by employing the Con-VAE with Latent Self-Organizing Map (SOM). SOM based topology may be learnt over the entire conditional latent space and the Con-VAE may encode each observation x_{i,t}, to a latent encoding. The SOM training step may then allocate each encoding to a cluster-centroid embedding of the conditional latent space. The total number of cluster embeddings may be a hyperparameter and may be derived empirically. The embeddings possess topological relationship and therefore, each cluster is more similar to its neighborhood clusters than others. Therefore, SOM like neighbourhood properties may be enforced on the latent space of the encoder which ensures to retain topological neighbourhood properties between data points in the adjacent time periods thereby helping in making associated predictions interpretable.

The SOM space is set to an n*n 2-D space, which may result in n² discrete SOM clusters. For each of the cluster, a normalised abnormality score may be generated using a deep-learning model, which may represent the color scale of the heat map. All SOM clusters that have values greater than 0.0 may be identified as dark/extremely abnormal and others may be identified as light/healthy clusters.

Predicting the trajectory of abnormality of the each user may include generating predictions for subsequent time steps within the mapped latent space by employing the LSTM network with the Attention Layer. The Attention Layer may identify one or more dominant time-steps in the predicted trajectory that lead to the predicted time-steps.

In an embodiment of the present invention, the abnormality predictor 110 may be further configured to identify platform activity features which have temporal relationship in explaining the trajectories of the extremely abnormal users by employing a SHAP (SHapley Additive explanations) based model on the identified one or more dominant time-steps. A pre-defined count of Shapley values may be obtained per SOM cluster and based on the obtained values at each of the dominant time-steps, the extent of acceleration amongst each of the respective features may be measured. These features are then ordered on their average Shapley weights values followed by the magnitude of acceleration during the period of attention.

Thus, analyzing the activity of certain users classified as sustained abnormal users may indicate the aspects leading to the abnormal activity and pathway of the activities, which further enables in identifying extremely abnormal users which require immediate attention in taking actions to prevent furtherance of the extreme activities. In an embodiment of the present invention, the abnormality predictor 110 may be further configured to identify extremely abnormal users based on the predicted trajectories of the sustained abnormal users for taking actions to prevent abnormal user activities of the identified extremely abnormal users. The users with a high number of time steps indicative of increasing abnormality within the mapped latent space may be identified as extremely abnormal users.

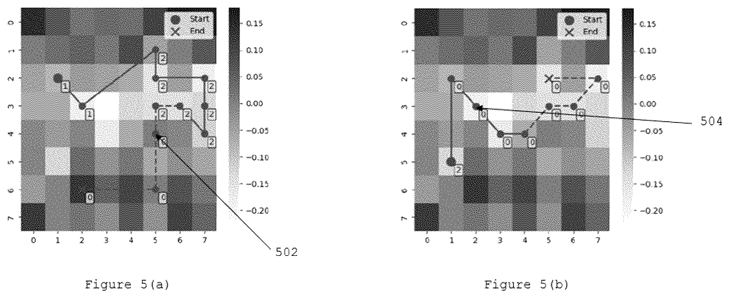

FIGS. 5(a) and 5(b) illustrate trajectories of abnormality of different users in accordance with an exemplary embodiment of the present invention. The FIGS. 5(a) and 5(b) each show a heat map on an 8*8 grid with 64 SOM clusters. The known portion of the trajectory of the each user is represented with solid lines and the predicted portions with dotted lines. According to the trajectory of the first user shown in the FIG. 5(a), it may be interpreted that the user's activities may move towards extreme abnormality. According to the trajectory of the second user shown in the FIG. 5(b), it may be interpreted that the user's activities may move towards reduced abnormality. Additionally, the conditions associated with the time-steps in the trajectory may be identified for interpreting the corresponding psychological states of the user affecting the platform activities.

Further, the dominant time-steps identified by the Attention Layer enable reasoning for the predictions. As shown in the FIG. 5(a), the attention point at 10^{th} time-step 502 may indicate that for the user 10^{th} time step majorly contributed in predicting increased abnormal activities. The attention point may further indicate the dominant feature of the user's activities. For example, such time-step of a user interacting on a gaming platform may indicate the dominant feature to be “add cash failure”. Similarly, as shown in the FIG. 5(b), the attention point at 3^{rd} time-step may indicate that for the user 3rd time step 504 majorly contributed in predicting decreased abnormal activities. In another example, such time-step of a user interacting on the gaming platform may indicate the dominant feature to be “total games played”. In this example it may be understood that, the healthy trajectory of the user may be due to self-moderation of the user by reducing the number of games played.

In an embodiment of the present invention, the intervention module 112 may be configured to communicate information related to abnormality assessment with the identified extremely abnormal users based on the predicted trajectories. In an embodiment of the present invention, the intervention module 112 may be further configured to estimate a level of intervention required based on the information communicated with the extremely abnormal users for determining the actions to be taken for preventing abnormal activities of the identified extremely abnormal users.

Communicating the information may include activities such as surveying which comprise providing the each user with queries to obtain user information regarding one or more aspects of the user's platform activities, based on which, psychological and resource conditions of the user may be estimated. Further, based on the estimated psychological and resource conditions of the user, the user may be assigned a required level of intervention. The queries may be generated based on the topological data from the SOM and the features identified via values which provide for Shapley interpretability and explainability of the trajectories.

In an embodiment of the present invention, based on the estimated conditions of responsive users, additional assessment information may be communicated with those users indicative of requiring higher level of intervention. For example, such users with high level of intervention requirement may be directed to counselling programs. Based on the user responses to the additional communication, type of actions to be taken on each user may be determined. The actions may include, without any limitation, abstinence, adjustment of resource limits and adjustment of interaction limit. The obtained user information in response to the queries may be assigned a score and based on the score a user may be further assigned the required level of intervention for either for taking appropriate intervention measures or releasing from the intervention process and may be declared healthy.

For example, a user showing positive detection and identified with the feature of add cash failures during wallet refill transactions due to insufficient funds may be questioned about the user's financial capacity and instances of borrowing assets from friends and family. Similarly, direct intervention by lowering down the add cash limits of the user on the platform may be adopted, so that any add cash beyond the approved limit may be blocked on the platform.

Certain users may be unresponsive to the communication as they may intend not to disclose information that may result in controlled platform activity. Therefore, such unresponsive users may be assigned a medium level of intervention. No intervention actions may be taken on those users indicative of requiring very low of intervention. However, the users with low level of intervention assigned may include certain users who intend not to disclose information that may result in controlled platform activity and thus provide responses that may result in low level of requirement for intervention. Since the low level of intervention assigned to such users may be a false positive, if no intervention is taken, such extremely abnormal users may continue to engage in the abnormal activities, and may thus build-up resource losses and further isolate themselves psychologically due to the losses. Therefore, a user with low level assigned at the initial stage of intervention, and is identified as an extremely abnormal user during subsequent instances, for a pre-defined number of times, within a pre-defined duration, may be re-assigned a high level of intervention requirement and may be subject to the additional assessment communication.

The operation of the present invention is elaborated with a use case scenario. In a scenario, where a plurality of users may be playing games on an online gaming platform, one or more users from the plurality of users may engage in abnormal activities such as problem gaming comprising compulsive gaming or irresponsible gameplay. In this scenario, the system 100 may be implemented, to prevent the problem gaming associated with the users of the gaming platform.

In operation, the gameplay data of the each user of the gaming platform may be obtained from the user devices 102 for processing by the system 100. Initially, the user identifier 104 may identify the one or more abnormal users based on the platform interaction data comprising the user's gameplay data, by employing the deep-learning model. For identification of the one or more abnormal users, initially, various features of the gameplay may be identified from the gameplay data, such as, for example, count of add cash, count of late night games, games lost to total games ratio, count of limit change and total loss incurred in a certain period.

Further, time series of each of the features may be obtained for a pre-defined duration, by employing a time series forecasting technique and the deep learning model may further predict the abnormality scores of the user based on hyperparameters of the time-series model employed. Then, the abnormality analyzer engine 106 engine may receive data related to abnormal activities associated with the gaming platform interactions of one or more pre-identified abnormal users which includes gameplay data and abnormality scores of the user over the pre-defined duration.

Upon obtaining the data, the abnormality analyzer engine 106 may further estimate one or more parameters indicative of extent of abnormality associated with each of the one or more pre-identified users which may include average abnormality score acceleration, area under the curve of abnormality scores, angular displacements of consequent abnormality scores and cumulative loss of assets associated with the users over a pre-defined period.

Upon estimating the parameters, the user classification module 108 may estimate a net abnormality score of the each user based on the one or more parameters indicative of the extent of abnormality of the user as a weighted sum of the one or more parameters, for classifying the one or more pre-identified abnormal users based on the estimated net scores. Further, the user classification module 108 may classify the pre-identified abnormal users into sustained abnormal users and instantaneous abnormal users based on the net abnormality score of the each user, by employing elbow point identification technique.

Next, the abnormality predictor 110 may predict trajectory of abnormality of each of the sustained abnormal users based on the received data of the classified one or more sustained abnormal users by employing a deep learning neural network. The abnormality predictor 110 may determine one or more conditions associated with psychological states of the sustained abnormal users for predicting the trajectories by employing a Deep Markov Model (DMM) and a Conditional Network. The abnormality predictor 110 may further generate latent encodings for the received platform interaction data of the sustained abnormal users for mapping to latent space associated with the determined one or more conditions by employing a Conditional Variational Auto-Encoder (Con-VAE) with Latent Self-Organizing Map (SOM) such that, SOM like neighbourhood properties may be enforced on the latent space of the encoder which ensures to retain topological neighbourhood properties between data points in the adjacent time periods enabling interpretability of predictions.

Predictions for subsequent time steps within the mapped latent space may be generated by employing a Long short-term memory network with an Attention Layer and the Attention Layer may identify one or more dominant time-steps in the predicted trajectory that lead to the predicted time-steps. The abnormality predictor 110 may further identify platform activity features which have temporal relationship in explaining the trajectories of the extremely abnormal 1 users by employing a SHAP (SHapley Additive explanations) based model on the identified one or more dominant time-steps.

Next, the abnormality predictor 110 may identify extremely abnormal users comprising users with a high number of time steps indicative of increasing abnormality within the mapped latent space based on the predicted trajectories, for taking actions to prevent abnormal user activities. Thereafter, the intervention module 112 may communicate information related to abnormality assessment with the identified extremely abnormal users based on the predicted trajectories and estimate a level of intervention required for preventing abnormal activities of the identified extremely abnormal users. Based on the user responses to the additional communication, type of actions to be taken on each user may be determined, such as abstinence, adjustment of resource limits and adjustment of interaction limit.

The present invention may enable forecasting, interpreting and explaining any time series data with multiple feature dimensions. Other exemplary user case scenarios of the present invention may thus include, without any limitation, fraudulent transactions, network intrusion, digital media addiction and e-commerce shopping. Since the present invention employs DMM and Con-VAE, the present invention may enable processing of random and noisy platform interaction data and thus enable prediction of randomness and retaining interpretability of the trajectories.

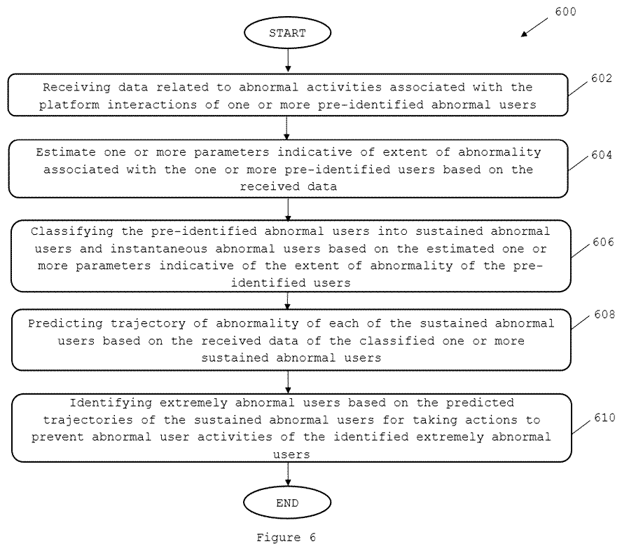

FIG. 6 is a flowchart 600 illustrating a method for preventing abnormal user activities associated with interactive platforms in accordance with an embodiment of the present invention. The method starts at step 602. At step 602, receiving data related to abnormal activities associated with the platform interactions of one or more pre-identified abnormal users may be received. The data related to abnormal activities of a pre-identified user may include platform interaction data and abnormality scores of the user over a pre-defined duration. The one or more users may be pre-identified as abnormal based on the platform interaction data and the abnormality scores of the user may be generated by employing a deep-learning model.

Next, at step 604, one or more parameters indicative of extent of abnormality associated with each of the one or more pre-identified users may be estimated based on the received data. The one or more parameters indicative of the extent of abnormality of a user may include average abnormality score acceleration, area under the curve of abnormality scores, angular displacements of consequent abnormality scores and cumulative loss of assets associated with the users over a pre-defined period. Further, a net abnormality score of the each user may be estimated based on the one or more parameters indicative of the extent of abnormality of the user for classifying the one or more pre-identified abnormal users into the sustained abnormal users and the instantaneous abnormal users.

Next, at step 606, the pre-identified abnormal users may be classified into sustained abnormal users and instantaneous abnormal users based on the estimated one or more parameters indicative of the extent of abnormality of the pre-identified users. The one or more sustained abnormal users and the one or more instantaneous abnormal users may be classified by employing elbow point identification.

Next, at step 608, trajectory of abnormality of each of the sustained abnormal users maybe predicted based on the received data of the classified one or more sustained abnormal users. Further, one or more conditions associated with psychological states of the sustained abnormal users may be determined for predicting the trajectories by employing a Deep Markov Model and a Conditional Network. Further, latent encodings may be generated for the received platform interaction data of the sustained abnormal users for mapping to latent space associated with the determined one or more conditions by employing a Conditional Variational Auto-Encoder with Latent Self-Organizing Map.

The Self-Organizing Map based topology may be learnt over the entire conditional latent space, the Conditional Variational Auto-Encoder may encode platform interaction data to latent encodings, which may be allocated to cluster-centroid embeddings of the conditional latent space such that, SOM like neighbourhood properties maybe enforced on the latent space of the encoder which ensures to retain topological neighbourhood properties between data points in the adjacent time periods enabling interpretability of the predictions. Predicting trajectory of the each user may include generating predictions for subsequent time steps within the mapped latent space by employing a Long short-term memory network with an Attention Layer. The Attention Layer may be configured to identify one or more dominant time-steps in the predicted trajectory that lead to the predicted time-steps.

Thereafter, at step 610, extremely abnormal users may be identified based n the predicted trajectories of the sustained abnormal users for taking actions to prevent abnormal user activities of the identified extremely abnormal users. The users with a high number of time steps indicative of increasing abnormality within the mapped latent space maybe identified as extremely abnormal users.

In an embodiment of the present invention, the method includes identifying platform activity features which have temporal relationship in explaining the predicted trajectory by employing a SHAP (SHapley Additive explanations) based model on the identified one or more dominant time-steps.

In an embodiment of the present invention, the method further comprises communicating information related to abnormality assessment with the identified extremely abnormal users the based predicted trajectories and estimating a level of intervention required based on the information communicated with the extremely abnormal users for determining the actions to be taken for preventing abnormal activities of the identified extremely abnormal users.

Thus, the present invention provides a mechanism to prevent abnormal user activities associated with interactive platforms. Since the mechanism is configured to identify the extremely abnormal users based on the processed platform interaction data, dependency on various sources of data is avoided. Since the mechanism is configured to provide trajectories on a self-organized map topography, the trajectory of the users are interpretable in respect of abnormality levels of the users. Further, since the mechanism is configured to identify features of activities by employing SHAP models, the trajectory of the users can be explained in respect of features leading to the path of abnormality of the users. Therefore, the interpretability and explainability of the abnormality trajectory of a user is enabled by the present invention providing for how and why a user is in an abnormal path of platform interactions, which further provides for identifying required intervention actions, thereby enabling preventing of abnormal user activities on the platforms.

Further, since the mechanism is configured to identify various parameters indicative of extent of abnormality of the pre-identified users, an accurate net abnormality score is estimated based on the abnormality scores, precise identification of the abnormal users is provided by the present invention. Further, since the mechanism is configured to classify the users into sustained and instantaneous abnormal users based on the net abnormality scores over a period of time, false identification of the self-moderated users is prevented.

Since the mechanism is configured to automatically take actions to prevent abnormal activities of the users the users' activities are automatically moderated thus avoiding potential loss of resources of the users, which further enables the users to self-regulate their platform activities. Additionally since intervention actions are automatically taken users who are unresponsive to the intervention actions, those users who require support are identified by the present invention even when the users are non-participative. Further, since the mechanism is configured to direct certain users to additional intervention actions when repeatedly identified, even when the user provide false information to prevent invention actions, the present invention provides for highly efficient mechanism for identification of the abnormal users and preventing the abnormal activities. Additionally, the invention facilitates in spreading awareness on safe and responsible platform interactions.

While the exemplary embodiments of the present invention are described and illustrated herein, it will be appreciated that they are merely illustrative. It will be understood by those skilled in the art that various modifications in form and detail may be made therein without departing from or offending the scope of the invention as defined by the appended claims.

We claim:

1. A system (100) to prevent abnormal user activities associated with interactive platforms, the system (100) comprising:
an abnormality analyser engine (106) to:
receive data related to abnormal activities associated with the platform interactions of one or more pre-identified abnormal users;
estimate one or more parameters indicative of extent of abnormality associated with each of the one or more pre-identified users based on the received data;
a user classification module (108) to:
classify the pre-identified abnormal users into sustained abnormal users and instantaneous abnormal users based on the estimated one or more parameters indicative of the extent of abnormality of the pre-identified users;
an abnormality predictor (110) to:
predict trajectory of abnormality of each of the sustained abnormal users based on the received data of the classified one or more sustained abnormal users; and
identify extremely abnormal users based on the predicted trajectories of the sustained abnormal users for taking actions to prevent abnormal user activities of the identified extremely abnormal users.

2. The system (100) as claimed in claim 1, wherein the data related to abnormal activities of a pre-identified user includes platform interaction data and abnormality scores of the user over a pre-defined duration.

3. The system (100) as claimed in claim 2, wherein the abnormality scores of the user are generated and the one or more users are pre-identified as abnormal based on the platform interaction data by employing a deep-learning model.

4. The system (100) as claimed in claim 1, wherein the one or more parameters indicative of the extent of abnormality of a user include average abnormality score acceleration, area under the curve of abnormality scores, angular displacements of consequent abnormality scores and cumulative loss of assets associated with the users over a pre-defined period.

5. The system (100) as claimed in claim 1, wherein the user classification module (108) is to further estimate a net abnormality score of the each user based on the one or more parameters indicative of the extent of abnormality of the user for classifying the one or more pre-identified abnormal users into the sustained abnormal users and the instantaneous abnormal users.

6. The system (100) as claimed in claim 1, wherein the one or more sustained abnormal users and the one or more instantaneous abnormal users are classified by employing elbow point identification.

7. The system (100) as clamed in claim 1, wherein the abnormality predictor (110) is to further determine one or more conditions associated with psychological states of the sustained abnormal users for predicting the trajectories by employing a Deep Markov Model and a Conditional Network.

8. The system (100) as claimed in claim 7, wherein the abnormality predictor (110) is to further generate latent encodings the for received platform interaction data of the sustained abnormal users for mapping to latent space associated with the determined one or more conditions by employing a Conditional Variational Auto-Encoder with Latent Self-Organizing Map.

9. The system (100) as claimed in claim 8, wherein the Self-Organizing Map based topology is learnt over the entire conditional latent space, the Conditional Variational Auto-Encoder encodes platform interaction data to latent encodings, which are allocated to cluster-centroid embeddings of the conditional latent space such that, SOM like neighbourhood properties are enforced on the latent space of the encoder which ensures to retain topological neighbourhood properties between data points in the adjacent time periods enabling interpretability of the predictions.

10. The system (100) as claimed in claim 8, wherein predicting trajectory of the each user includes generating predictions for subsequent time steps within the mapped latent space by employing a Long short-term memory network with an Attention Layer.

11. The system (100) as claimed in claim 10, wherein the users with a high number of time steps indicative of increasing abnormality within the mapped latent space are identified as extremely abnormal users.

12. The system (100) as claimed in claim 10, wherein the Attention Layer is to identify one or more dominant time-steps in the predicted trajectory that lead to the predicted time-steps.

13. The system (100) as claimed in claim 12, wherein the abnormality predictor (110) is to further identify platform activity features which have temporal relationship in explaining the predicted trajectory by employing a SHAP (SHapley Additive explanations) based model on the identified one or more dominant time-steps.

14. The system (100) as claimed in claim 1, further includes an intervention module (112) to:
communicate information related to abnormality assessment with the identified extremely abnormal users based on the predicted trajectories; and
estimate a level of intervention required based on the information communicated with the extremely abnormal users for determining the actions to be taken for preventing abnormal activities of the identified extremely abnormal users.

15. A method for preventing abnormal user activities associated with interactive platforms, the method comprising:
receiving data related to abnormal activities associated with the platform interactions of one or more pre-identified abnormal users;
estimating one or more parameters indicative of extent of abnormality associated with each of the one or more pre-identified users based on the received data;
classifying the pre-identified abnormal users into sustained abnormal users and instantaneous abnormal users based on the estimated one or more parameters indicative of the extent of abnormality of the pre-identified users;
predicting trajectory of abnormality of each of the sustained abnormal users based on the received data of the classified one or more sustained abnormal users; and
identifying extremely abnormal users based on the predicted trajectories of the sustained abnormal users for taking actions to prevent abnormal user activities of the identified extremely abnormal users.

16. The method as claimed in claim 15, wherein the data related to abnormal activities of a pre-identified user includes platform interaction data and abnormality scores of the user over a pre-defined duration.

17. The method as claimed in claim 16, wherein the abnormality scores of the user are generated and the one or more users are pre-identified as abnormal based on the platform interaction data by employing a deep-learning model.

18. The method as claimed in claim 15, wherein the one or more parameters indicative of the extent of abnormality of a user include average abnormality score acceleration, area under the curve of abnormality scores, angular displacements of consequent abnormality scores and cumulative loss of assets associated with the users over a pre-defined period.

19. The method as claimed in claim 15, further includes estimating a net abnormality score of the each user based on the one or more parameters indicative of the extent of abnormality the of user for classifying the one or more pre-identified abnormal users into the sustained abnormal users and the instantaneous abnormal users.

20. The method as claimed in claim 15, wherein the one or more sustained abnormal users and the one or more instantaneous abnormal users are classified by employing elbow point identification.

21. The method as clamed in claim 15, further includes determining one or more conditions associated with psychological states of the sustained abnormal users for predicting the trajectories by employing a Deep Markov Model and a Conditional Network.

22. The method as claimed in claim 21, further includes generating latent encodings for the received platform interaction data of the sustained abnormal users for mapping to latent space associated with the determined one or more conditions by employing a Conditional Variational Auto-Encoder with Latent Self-Organizing Map.

23. The method as claimed in claim 22, wherein the Self-Organizing Map based topology is learnt over the entire conditional latent space, the Conditional Variational Auto-Encoder encodes platform interaction data to latent encodings, which are allocated to cluster-centroid embeddings of the conditional latent space such that, SOM like neighbourhood properties are enforced on the latent space of the encoder which ensures to retain topological neighbourhood properties between data points in the adjacent time periods enabling interpretability of the predictions.

24. The method as claimed in claim 22, wherein predicting trajectory of the each user includes generating predictions for subsequent time steps within the mapped latent space by employing a Long short-term memory network with an Attention Layer.

25. The method as claimed in claim 24, wherein the users with a high number of time steps indicative of increasing abnormality within the mapped latent space are identified as extremely abnormal users.

26. The method as claimed in claim 24, wherein the Attention Layer is configured to identify one or more dominant time-steps in the predicted trajectory that lead to the predicted time-steps.

27. The method as claimed in claim 26, further comprises identifying platform activity features which have temporal relationship in explaining the predicted trajectory by employing a SHAP (SHapley Additive explanations) based model on the identified one or more dominant time-steps.

28. The method as claimed in claim 15, further includes:
communicating information related to abnormality assessment with the identified extremely abnormal users based on the predicted trajectories; and
estimating a level of intervention required based on the information communicated with the extremely abnormal users for determining the actions to be taken for preventing abnormal activities of the identified extremely abnormal users.
